(19) United States
(12) Patent Application Publication
(10) Pub. No.: US 2016/0327120 A1
(43) Pub. Date: Nov. 10, 2016

(54) MOVEMENT TRANSFER SYSTEM OF CRANK-CONNECTING ROD TYPE INCLUDED IN CRANKSHAFT

(71) Applicant: Jairo Eduardo Leal Jimenez, Bogota,. D.C. (CO)

(72) Inventor: Jairo Eduardo Leal Jimenez, Bogota D.C. (CO)

(21) Appl. No.: 15/108,957

(22) PCT Filed: Dec. 31, 2013
(86) PCT No.: PCT/IB2013/061460

§ 371 Date: Jun. 29, 2016

(51) Int. Cl. F16F 15/28; F16C 7/02; F16C 11/02; F16C 3/06

(52) U.S. Cl. CPC F16F 15/283; F16C 3/06; F16C 7/02; F16C 11/02

(57) ABSTRACT

The invention relates to a connecting rod/crank transmission system in which the force (F1) applied by the connecting rod is transmitted via a pin (1) to two diverging arms (7, 8) of the crank that are joined to the counterweight (3) thereof at points (C, D) located at a radial distance (r2) greater than the radial distance (r2) of the connecting rod pin (1), in order to increase the torque transmitted and the performance of the system. The invention also relates to a crankshaft formed with said cranks.

### AREA OF INVENTION

The current invention is in the field of Mechanical Engineering particularly to the connecting rod-crank mechanism, applicable to machines and engines where this mechanism is applied such as reciprocating internal combustion engines, pumps and compressors.

### INVENTION BACKGROUND

This invention is related to the connecting rod (conrod) and crank/crankshaft mechanism to convert movement used in a reciprocating internal combustion engine and similar machines.

Searching to improve fuel performance in engines there have been diverse developments such as fuel optimization usages and more efficient engines. However the crankshaft hasn't been modified in decades and its mechanical principle is unaltered.

The crankshaft is one of the most important parts of the Internal Combustion Engine (ICE); it can be described as a solid rigid body with translation of mass center and rotation about an axis. The crankshaft converts reciprocating motion (linear motion by the piston) in rotational motion, produced by the pressure of the combustion gases and the inertial masses through the connecting rod to the crankshaft and finally to the flywheel and the wheels of a vehicle.

The crankshaft transmits the effort produced by the combustion thus suffering various kinds of strains like torsion, flexion, vibration and shear. It is also submitted to centrifugal force and must have balance masses to compensate for these rotational forces in each piston.

The old steam locomotives used a connecting rod-crank mechanism to rotate the wheels straight from the steam engine. The connecting rod moved the wheels directly unlike the internal combustion engines that have a gearshift.

The crankshaft is part of the connecting rod-crank mechanism; it is part of the system that transforms the thermal energy from combustion to mechanical energy. Crankshafts are widely used in internal combustion engines for vehicles and similar machines in which the linear movement of pistons (reciprocating movement) is transformed in rotational movement of the crankshaft.

Despite the proven reliability of the connecting rod-crank mechanism there is still an opportunity to provide a system that improves engine efficiency and reduces fuel consumption.

There isn't a description in previous works of a movement transmission system of the connecting rod-crank/crankshaft type that can produce relevant reduction of fuel consumption in an Internal Combustion Engine.

This invention proposes a crankshaft with an improved connecting rod-crank mechanism that improves with very good results the fuel consumption in an Internal Consumption Engine.

The actual connecting rod-crank mechanism, for example, the crankshaft as the one in FIG. 9 has the following parts: connecting rod journal (1), main bearing journal (2), balance masses or counterweights (3) and crank arm (4). The pressure exerted by the gases within the cylinder produce a force transmitted to the piston and the connecting rod connected to the journal (1) that begins translational motion around the main bearing journal (2) and the resulting rotation around its axis. The balance mass or counterweight (3) compensates dynamically the system and the arm (4) connects pints A and B (FIG. 8); this is the momentum radius that suffers flexion thus requiring more material to increase its mechanical resistance.

The torque in the crankshaft is given by the force applied to the connecting rod journal (1) between the axis of the connecting rod journal and the axis of the main journal (distance A-B).

This invention improves the connecting rod-crank system by generating a physical separation of the main journal (2) and the connecting rod journal (1) that in the current design are connected by the crank arm who is affected by the flexion strain. This single arm is replaced in the new design with two arms from the connecting rod journal from two different angles to the outer circle of the crankshaft. These two arms are called the compression arm (7) and the tension arm (8); thus, the force exerted by the connecting rod (F1) over the journal (1) is split up in two vector forces: compression force (F2) and tension force (F3) given by the compression arm (7) and tension arm (8) correspondingly. The force is applied at points C and D with a radius r2 longer than previous radius r1 (FIG. 2).

The torque or momentum is the force applied to a body multiplied by the distance from the axis and it is measured in Newtons/meter. Therefore momentum is force times distance (L=F*d); since the new design the distance r2 y greater than r1, applying the same force the momentum will be greater. Hence, with r2 (new design) it is required a lesser force to achieve the same momentum as with r1.

### INVENTION SUMMARY

The invention in this current request provides an upgraded connecting rod/crank system where the flexion arm is replaced by two arms from the journal in divergent angles outer circle of the crankshaft. These two new arms are named Compression arm and Tension arm; therefore the force applied to the connecting rod journal is split up in two vector forces: compression and tension forces.

Additionally the present document includes the crankshaft that incorporates the upgraded connecting rod/crank system described.

The advantages and objectives of the invention will be cleared in the detailed description, the figures attached and the claims responses.

### DRAWINGS BRIEF DESCRIPTION

FIG. 1. First version of the new motion transmission system. Transversal view.

FIG. 2. Diagram of the forces in new system. View of piston, connecting rod/crank and crankshaft.

FIG. 3. First version crankshaft full view.

FIG. 4. Second version of the new motion transmission system. Transversal view.

FIG. 5. Second version crankshaft full view.

FIG. 6. Third version of new motion transmission system. Transversal view.

FIG. 7. Third version crankshaft full version.

FIG. 8. Conventional motion transmission system. Transversal view.

FIG. 9. Conventional crankshaft full view.

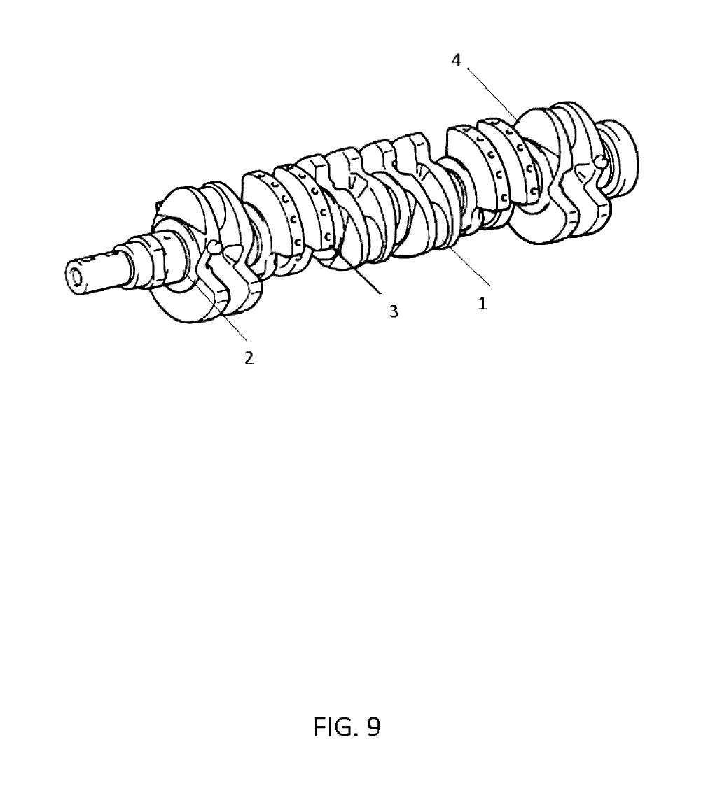

### LISTED ELEMENTS OF THE INVENTION

Connecting rod/crank journal (1)
Main journal (2)
Counterweight/Balance masses (3)

### Crank arm (4)

Crankshaft axis (5)

### Crankshaft (6)

### Compression arm (7)

### Tension arm (8)

### Point A

### Point B

Peripheral/Outer circle point C
Peripheral/Outer circle point D

### Radius r1

### Radius r2

Force from connecting rod/crank (F1)
Compression force (F2)
Compression force (F3)

### DETAILED DESCRIPTION OF INVENTION

The invention involves the connecting rod/crank mechanism where the force applied by the connecting rod (F1) over the journal (1) is split up in two vector forces: compression force (F2) and tension force (F3). This physical separation is achieved by replacing the crank arm (4) that supported tension strain with two arms that come from the connecting rod journal in divergent angles up to the peripheral circle of the crankshaft. These two new arms are named compression (7) and tension (8) arms.

By physically separating the force that is now applied over points C and D with a resulting radius r2 (C-B and D-B) greater than radius r1 of the traditional connecting rod/crank system. The longer radius (distance to a rotating axis) allows a higher torque or momentum using the same force since Torque is Force multiplied by distance (L=F*d).

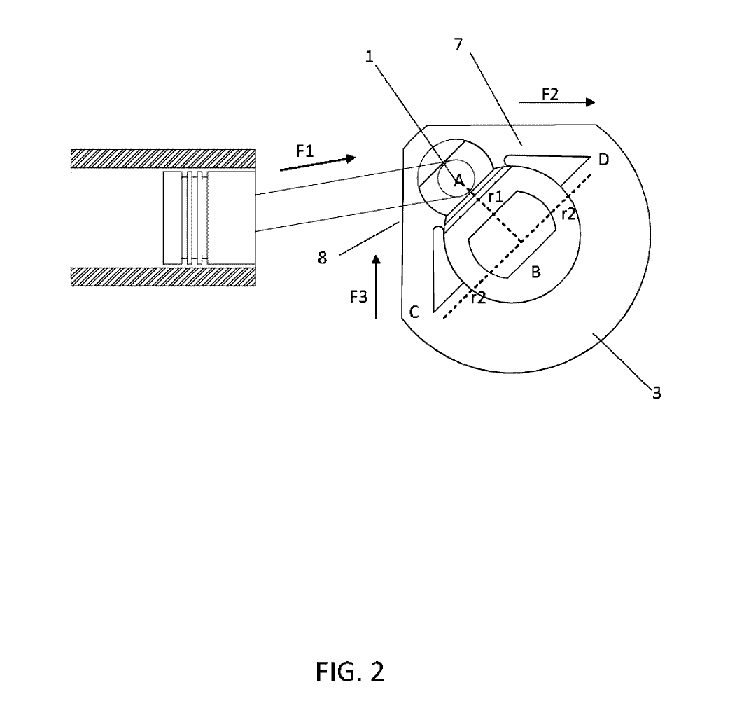

The result is a connecting rod/crank motion transmission system (as shown in FIG. 2) in which two divergent arms (7,8) reach out from the connecting rod/crank journal (1), that behave under a compression force (F2) and tension force (F3), transmit the force from the connecting rod/crank (F1) to two peripheral points (C, D) located where the tension and compression arms connect with the counterweight (3) applied with a radius r2 that is longer then radius r1 resulting in a higher torque using the same force from the engine.

An essential characteristic of the invention is the separation of the force from the connecting rod/crank (F1) into two forces (F2, F3), where F2 is applied through the Compression Arm (7) and F3 is applied through the Tension Arm (8), as shown in FIG. 2.

The force from the connecting rod (F1) applied to the connecting rod journal (1) is transmitted to points C and D through the Compression arm (7) and the Tension arm (8). F2 is a compression force applied to point D and F3 is a tension force applied to point C; both are applied at a radius r2 to the main journal to rotate the system. Since applied through a longer radius the torque is larger.

This invention has applied the modified mechanism connecting rod/crank in different types of crankshafts for Internal Combustion Engines with very good results improving the fuel consumption.

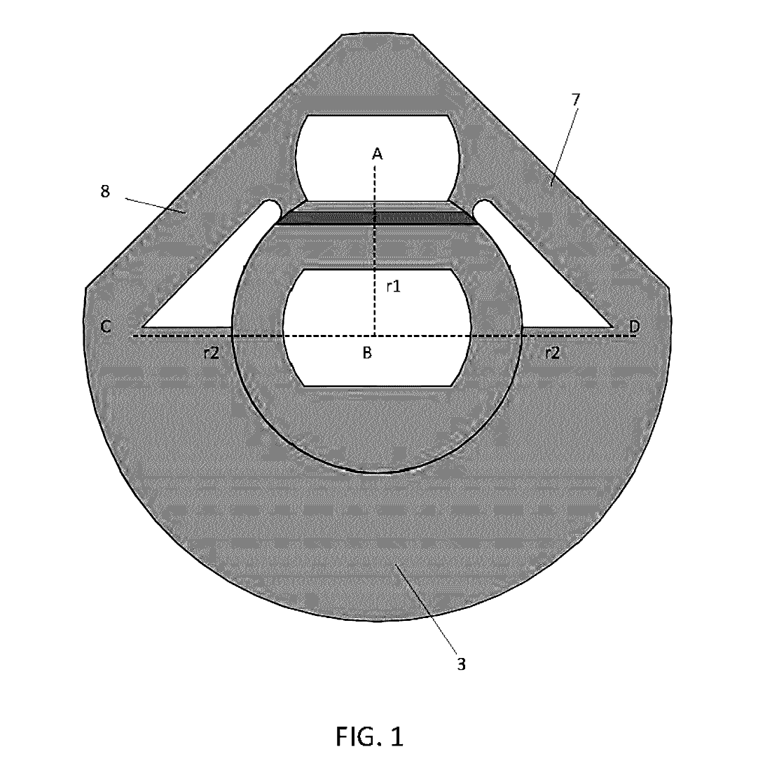

The Crankshaft (6) of the invention has the system of two divergent arms, compression arm (7) and tension arm (8) from the connecting rod/crank journal. FIGS. 1,4,6 show the arms in different crankshaft designs.

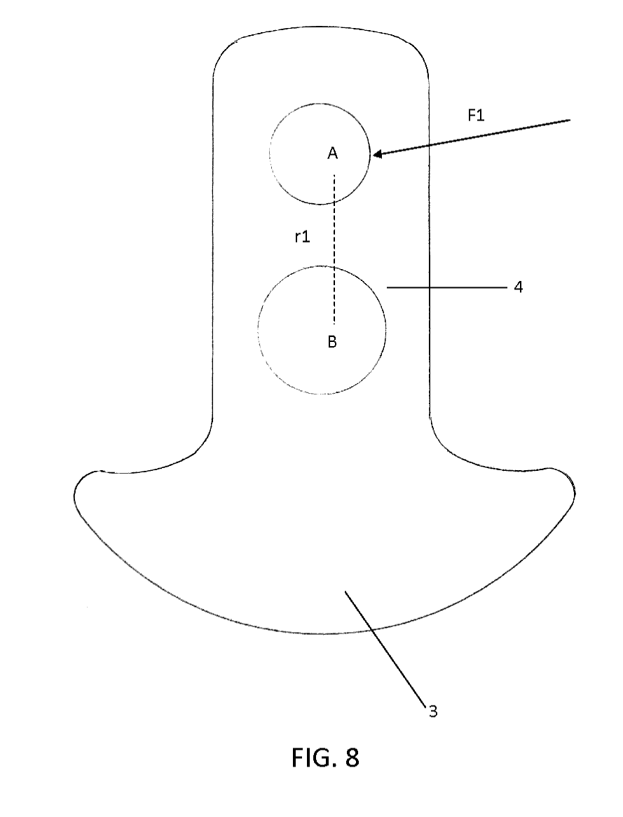

The main feature of the crankshafts (6) with the invention is the radius r2 is longer than the radius r1 of the actual design of crankshafts as seen in FIG. 8.

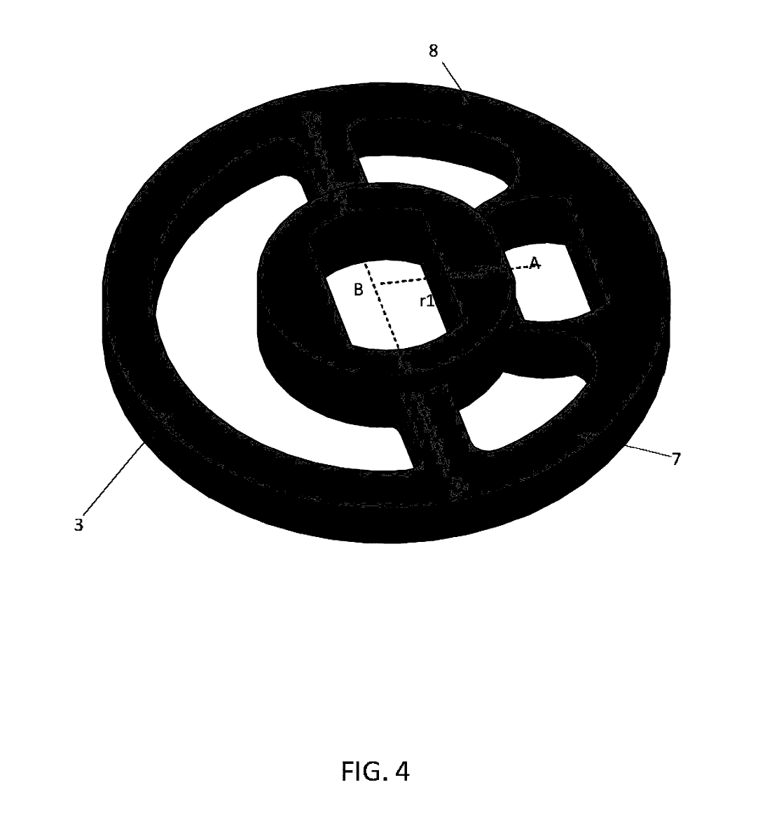

One of the versions of the invention shown in FIGS. 4,5,6,7 has the crankshaft (6) with an inner circle that acts as a flywheel for the engine.

Another version has the crankshaft with two circles that also act as flywheels for the motor.

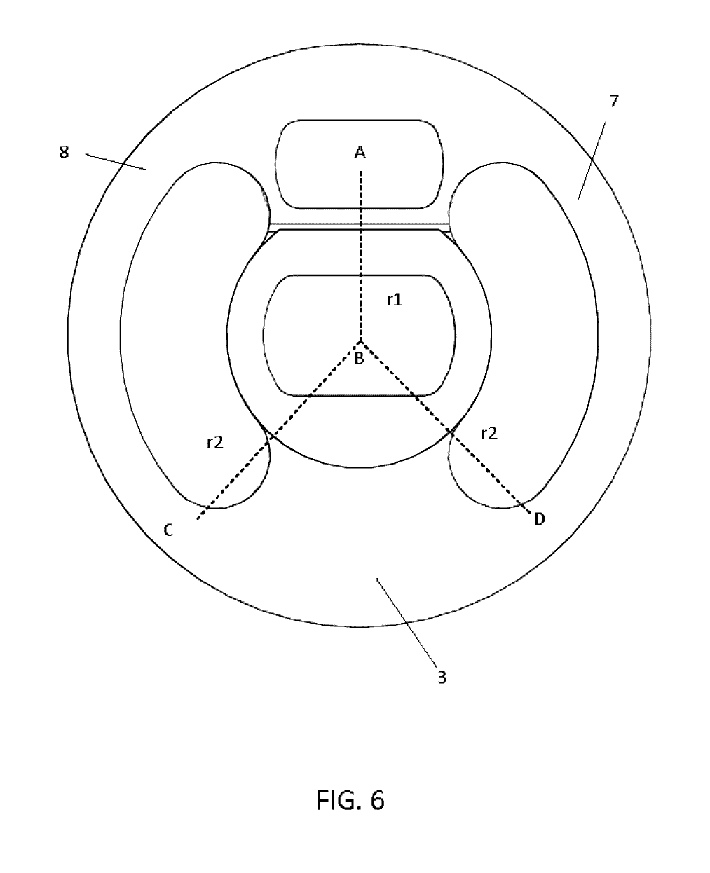

As shown in FIGS. 4 and 6, the compression arms (7) and the tension arms (8) and the counterweights (3) are replaced by semicircles, forming together complete circles; their masses act as flywheels for the structure.

This feature regarding the flywheels helps the engine work smoother, extend its life cycle and have an easier acceleration when passive.

FIG. 1 describes a solid according to the first version of the motion transmission system where the counterweight (3) is portrayed by a solid semicircle, the compression (7) and tension (8) arms form a triangle with a base of the added radii r2.

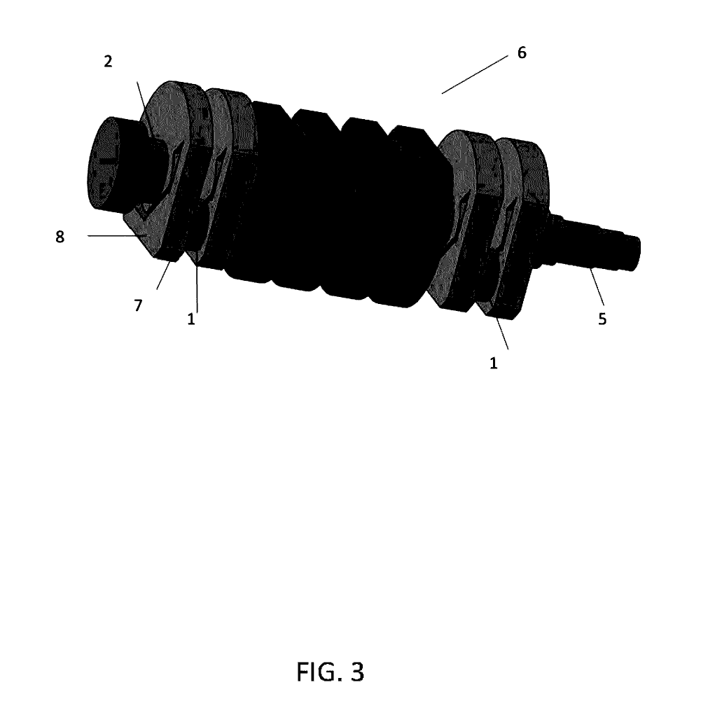

FIG. 3 depicts the crankshaft with the first version of the motion transmission system described in this invention.

FIG. 4 shows the solid of the second version of the motion transmission system. Again the counterweight (3) is portrayed by a hollow semicircle, the compression (7) and tension (8) arms are circular and encircle two holes between radius r1 and the radii r2.

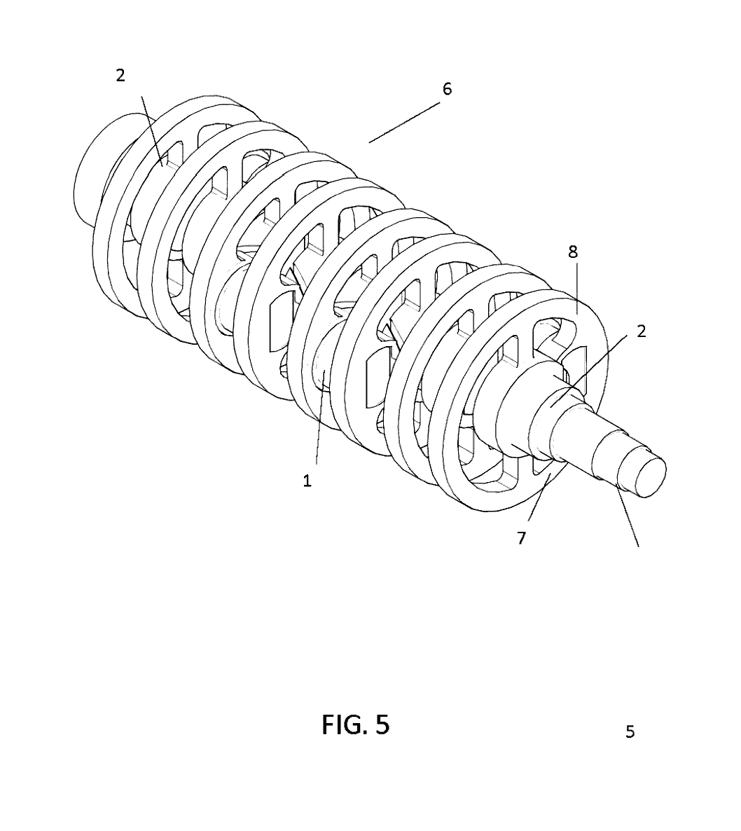

FIG. 5 depicts the crankshaft with second version of the motion transmission system invented.

FIG. 6 shows the solid of the third version of the motion transmission system. The counterweight (3) is portrayed by a solid mass and the compression (7) and tension (8) arms that encircle two hollow moon shaped figures.

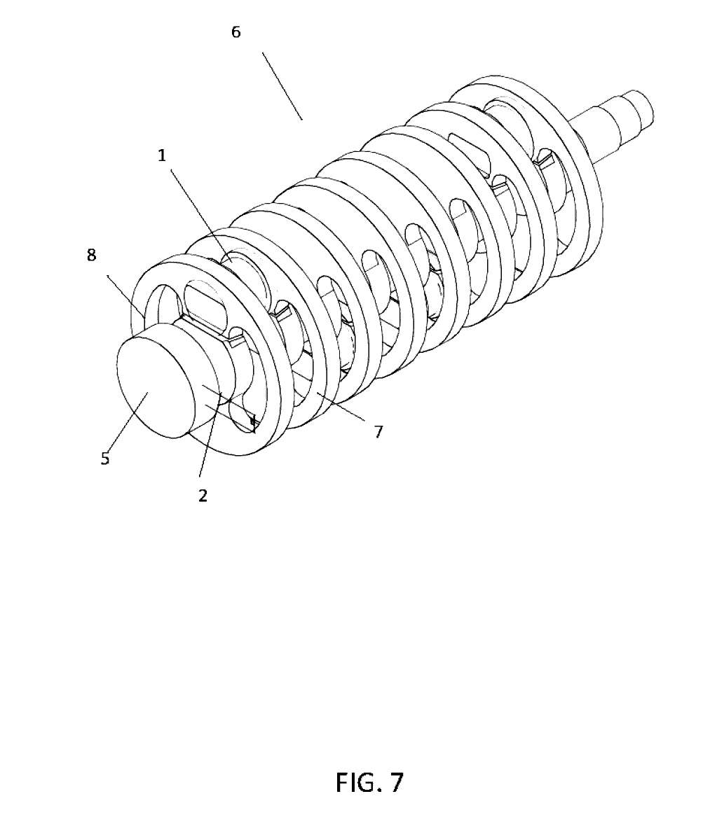

FIG. 7 depicts the crankshaft with the third version of the motion transmission system invented.

In evaluations, the applied invention with the upgraded connecting rod/crank system used in a crankshaft fuel consumption has been 60% less than the regular usage.

The preferred variations of the invention have been presented above applied in crankshafts; it is clear that any modification evident for any knowledgeable technical person is harnessed and protected under this invention.

### Examples

The 1.6 liter 2012 KIA CERATO FORTE has a conventional crankshaft with a radius r1=42.5 mm (0.0425 m).

The momentum (L1) in this crankshaft calculated as Force (F) by Distance (d), using F=4,000 Newton and d=r1=0.0425 m:

L1=F*r1

L1=4,000 N*0.0425 m=170 Nm

The calculated Torque (L1) is 170 Nm in the current conventional crankshaft.

In the same engine of the same vehicle the new crankshaft with the invention was installed (FIG. 4) with a measured radius r2=68 mm=0.068 m.

The force is now applied to points C and D with r2 (B-C, B-D) greater than r1 (segment A-B FIG. 8).

The momentum L2 in the modified crankshaft is calculated:

L2=F*r2

L2=4,000 N*0.068 m=272 Nm

The calculated Torque (L2) is 272 Nm, greater than L1 (conventional crankshaft design).

Comparing L2 and L1, calculating L2/L1=272 Nm/170 Nm=1.6. The calculated Torque of the modified crankshaft is 60% greater than the calculated Torque of the conventional one.

Since the force is generated by the pressure of the gases within the combustion chambers of the engine, maintaining all variables constant as the conventional crankshaft and based on the above calculations, using the modified crankshaft the engine would need 60% less energy to obtain the same Torque.

### Fuel Consumption

The modified crankshaft was installed in the 1.6 liter 2012 KIA CERATO FORTE according to the design in FIG. 4. Tests were run in the city of Bogotá, Colombia in urban roads.

The following are the measurement taken in the tests.

TABLE 1
Vehicle with conventional crankshaft

| | Test 1 | Test 2 | Test 3 | Test 4 | Test 5 | Test 6 | Test 7 | Average |
|---|---|---|---|---|---|---|---|---|
| Initial read | 93.831 | 96.658 | 102.975 | 105.240 | 109.111 | 215.426 | 219.219 | |
| (L) | | | | | | | | |
| Final read | 96.572 | 102.864 | 105.160 | 109.005 | 113.511 | 219.219 | 222.865 | |
| (L) | | | | | | | | |
| AVG | 9.9 | 9.0 | 8.9 | 9.9 | 9.7 | 12.3 | 11.9 | |
| Time (h) | 1:55 | 3:36 | 1:28 | 2:33 | 2:37 | | | |
| Distance | 32.6 | 78.2 | 28.7 | 41.8 | | | | |
| (Km) | | | | | | | | |
| Fuel used | 0.7241 | 1.639 | 0.5773 | 0.9947 | 1.162 | 1.0 | 0.96 | |
| (Gal) | | | | | | | | |
| Performance | 45 | 47.7 | 49.7 | 42 | 44.4 | 38.1 | 38.4 | 43.62 |
| (km/gal) | | | | | | | | |
| Performance | 28.12 | 29.81 | 31.06 | 26.25 | 27.75 | 23.81 | 24 | 27.28 |
| (mi/gal) | | | | | | | | |

Average performance with conventional crankshaft: 43.65 km/gal (27.28 mpg)

TABLE 2
Vehicle with modified crankshaft (invention)

| | Test 1 | Test 2 | Test 3 | Test 4 | Test 5 | Test 6 |
|---|---|---|---|---|---|---|
| Initial read | 671.475 | 675.878 | 680.642 | 682.776 | 684.839 | 689.340 |
| (L) | | | | | | |
| Final read | 673.414 | 677.803 | 682.776 | 684.839 | 686.789 | 691.386 |
| (L) | | | | | | |
| AVG | 7.0 | 6.8 | 6.9 | 6.7 | 7.7 | 6.8 |
| Time (h) | 1:42 | 1:12 | 1:48 | 1:20 | 1:35 | 1:34 |
| Distance | 36.5 | 36.5 | 36.5 | 36.5 | 36.5 | 36.5 |
| (Km) | | | | | | |
| Fuel used | 0.5123 | 0.5086 | 0.5638 | 0.5450 | 0.5152 | 0.5406 |
| (Gal) | | | | | | |
| Performance | 71.26 | 72.00 | 64.7 | 67 | 70.85 | 67.5 |
| (km/gal) | | | | | | |
| Performance | 44.53 | 45 | 40.43 | 41.87 | 44.28 | 42.18 |
| (mi/gal) | | | | | | |

TABL3 3
Comparative results between Vehicle with conventional crankshaft
and results with vehicle with modified crankshaft

| Average performance conventional | 43.65 km/gal (27.28 mpg) |
|---|---|
| crankshaft | |
| Average performance modified | 69.40 km/gal (43.37 mpg) |
| crankshaft | |
| Performance improvement | +59% |

### SUMMARY

The invention described in this document provides an upgraded connecting rod/crank system where the flexion arm is replaced with two arms originated from the connecting rod journal at divergent angles up to the peripheral circle of the crankshaft. These new arms are called Compression and Tension arms; therefore, the force applied by the connecting rod to the journal is divided in to vector forces: compression force and tension force.

Additionally, the request for invention provides a crankshaft that features this upgraded connecting rod/crank system invented.

1. A motion transmission system of connecting rod/crank type featuring two divergent arms (7,8) from the connecting rod journal, that behave under forces of compression (F2) and tension (F3). The force from the connecting rod (F1) is transmitted to two peripheral points (C,D) at the counterweight (3) with a radii r2, longer than radius r1 generating a greater momentum.

2. The system, according to claim 1, is characterized because the force from the connecting rod (F1) is divided in two forces (F2, F3), where F2 corresponds to the Compression arm (7) and F3 corresponds to the Tension arm (8).

3. The system, according to claim 1, is characterized because the force from the connecting rod (F1) applied over the connecting rod journal (1) is transmitted to points C and D through the Compression arm (7) and the Tension arm (8); the compression force (F2) is applied to point D and the tension force (F3) to point C having an impact over the main journal (2), therefore provoking the system to rotate with a greater momentum for having a greater radius where the forces are applied.

4. Crankshaft (6) characterized because from the connecting rod journal (1) two divergent arms extend named Compression arm (7) and Tension arm (8).

5. The crankshaft (6), according to claim 4, is characterized because the radii r2 are longer than radius r1 in the crank arm (4) from conventional crankshaft.

6. The crankshaft (6), according to claim 4, is characterized because additionally it features one circle for each cylinder of the engine; its mass works as a flywheel for the engine.

7. The crankshaft (6), according to claim 4, is characterized because additionally it features two circles for each cylinder of the engine; their masses work as flywheels.

8. The crankshaft (6), according to claim 4, is characterized because the Compression (7) and Tension (8) arms are replaced by semicircles, the counterweights (3) are also replaced by semicircles that are connected to the previous semicircles forming complete circles; their masses work as flywheels.

9. The crankshaft (6), according to claim 4, is characterized because the counterweight (3) is portrayed by a hollow semicircle and the Compression (7) and Tension (8) arms form a triangle that has a base equals to the sum of both radii r2.

10. The crankshaft (6), according to claim 4, is characterized because the counterweight (3) is portrayed by a hollow semicircle and the Compression (7) and Tension (8) arms are circular and encircle two spaces between radius r1 and radii r2.

11. The crankshaft (6), according to claim 4, is characterized because the counterweight (3) is portrayed by a solid shape and the Compression (7) and Tension (8) arms are circular and encircle two hollow spaces in the shape of a half-moon.
